(19) United States
(12) Patent Application Publication
(10) Pub. No.: US 2025/0077994 A1
(43) Pub. Date: Mar. 6, 2025

(54) APPLYING GRAPH REPRESENTATIONS OF USER SPACES

(71) Applicant: Capital One Services, LLC, McLean, VA (US)

(72) Inventors: Taylor TURNER, Richmond, VA (US); Galen RAFFERTY, Mahomet, IL (US); Samuel SHARPE, Cambridge, MA (US); Brian BARR, Schenectady, NY (US); Jeremy GOODSITT, Champaign, IL (US); Michael DAVIS, Arlington, VA (US)

(21) Appl. No.: 18/240,883

(22) Filed: Aug. 31, 2023

(51) Int. Cl. G06Q 10/0631; G06Q 10/067; G06Q 10/10; G06Q 10/1093; H04L 67/54

(52) U.S. Cl. CPC G06Q 10/063112; G06Q 10/067; G06Q 10/103; G06Q 10/1097; H04L 67/54

(57) ABSTRACT

In some implementations, an expert system may receive, from a user device, a data structure representing a project associated with a technical request. The expert system may map the data structure to a graph representation of a user space to determine a set of users. The expert system may determine a set of statuses, corresponding to the set of users, associated with availability of the set of users. The expert system may transmit, to the user device, instructions for a user interface including visual indicators for the set of users and the set of statuses. The expert system may receive, from the user device, an indication of a selected user from the set of users and may transmit a message addressed to the selected user.

### BACKGROUND

Assigning projects (e.g., information technology (IT) requests, feature requests, or code pull requests, among other examples) to appropriate users (e.g., IT specialists, computer programmers, or administrators) may be automatically allocated based on expertise. However, when an assigned user is unavailable, projects associated with the assigned user may languish, which can waste memory overhead on tracking information associated with the projects.

### SUMMARY

Some implementations described herein relate to a system for applying graph representations of user spaces. The system may include one or more memories and one or more processors communicatively coupled to the one or more memories. The one or more processors may be configured to transmit, to a user device, instructions for a user interface (UI) including one or more input elements. The one or more processors may be configured to receive, from the user device and based on the one or more input elements, a data structure from the user device representing a project associated with a technical request. The one or more processors may be configured to extract one or more keywords from the data structure. The one or more processors may be configured to extract one or more properties from the data structure. The one or more processors may be configured to determine a set of users for the project, based on applying the one or more keywords and the one or more properties to a graph representation of a user space. The one or more processors may be configured to determine a set of statuses, corresponding to the set of users, associated with availability of the set of users. The one or more processors may be configured to transmit, to the user device, instructions for a UI including visual indicators for the set of users and the set of statuses. The one or more processors may be configured to receive, from the user device, an indication of a selected user from the set of users. The one or more processors may be configured to transmit a message addressed to the selected user.

Some implementations described herein relate to a method of applying graph representations of user spaces. The method may include receiving, from a user device, a data structure representing a project associated with a technical request. The method may include mapping the data structure to a graph representation of a user space to determine a set of users. The method may include determining a set of statuses, corresponding to the set of users, associated with availability of the set of users. The method may include transmitting, to the user device, instructions for a UI including visual indicators for the set of users and the set of statuses. The method may include receiving, from the user device, an indication of a selected user from the set of users. The method may include transmitting a message addressed to the selected user.

Some implementations described herein relate to a non-transitory computer-readable medium that stores a set of instructions for applying graph representations of user spaces. The set of instructions, when executed by one or more processors of a device, may cause the device to receive a plurality of data structures representing a plurality of projects associated with technology. The set of instructions, when executed by one or more processors of the device, may cause the device to determine, for each data structure in the plurality of data structures, a corresponding set of users based on a graph representation of a user space. The set of instructions, when executed by one or more processors of the device, may cause the device to determine, for each corresponding set of users, an associated set of statuses indicating availability of the set of users. The set of instructions, when executed by one or more processors of the device, may cause the device to rank each corresponding set of users according to the associated set of statuses. The set of instructions, when executed by one or more processors of the device, may cause the device to transmit, for each data structure, a message addressed to a top-ranked user in the corresponding set of users.

### BRIEF DESCRIPTION OF THE DRAWINGS

FIGS. 1A-1D are diagrams of an example implementation relating to applying graph representations of user spaces to a new project, in accordance with some embodiments of the present disclosure.

FIGS. 2A-2C are diagrams of an example implementation relating to applying graph representations of user spaces to a backlog, in accordance with some embodiments of the present disclosure.

FIGS. 3A-3B are diagrams of example user interfaces (UIs) associated with user statuses described herein, in accordance with some embodiments of the present disclosure.

FIGS. 4A-4B are diagrams of example UIs associated with knowledge graphs described herein, in accordance with some embodiments of the present disclosure.

FIG. 5 is a diagram of an example environment in which systems and/or methods described herein may be implemented, in accordance with some embodiments of the present disclosure.

FIG. 6 is a diagram of example components of one or more devices of FIG. 5, in accordance with some embodiments of the present disclosure.

FIG. 7 is a flowchart of an example process relating to applying graph representations of user spaces, in accordance with some embodiments of the present disclosure.

### DETAILED DESCRIPTION

The following detailed description of example implementations refers to the accompanying drawings. The same reference numbers in different drawings may identify the same or similar elements.

Projects associated with technology (e.g., information technology (IT) requests, feature requests, or code pull requests, among other examples) are generally assigned to appropriate users (e.g., IT specialists, computer programmers, or administrators) for resolution and/or another type of processing. One way to automatically allocate projects to users is based on expertise. For example, a current set of projects may be represented by data structures, and keywords in the data structures may be mapped to keywords in previous data structures associated with a previous set of projects. Therefore, users that completed the set of previous projects may be assigned to the current set of projects based on keyword mapping.

However, when a user has a heavy workload, is not currently working, or will not be working in the near future (e.g., the next few hours or so), an assigned project may persist. When the assigned project persists, memory overhead is increased because a data structure associated with the assigned project cannot be archived. Additionally, network overhead is often increased because a person who submitted the assigned project may check a status of the assigned project repeatedly even though the user is not working on the assigned project.

Some implementations described herein enable assignment of projects to a set of users based on a combination of a user space and a set of statuses associated with the set of users. In other words, the projects are allocated based on a combination of expertise and availability. As a result, memory overhead is reduced because the projects will be completed faster, and thus data structures associated with the projects will be archived faster. Additionally, network overhead may be reduced because the projects will be completed faster, and thus people who submitted the projects will perform fewer status checks on the projects.

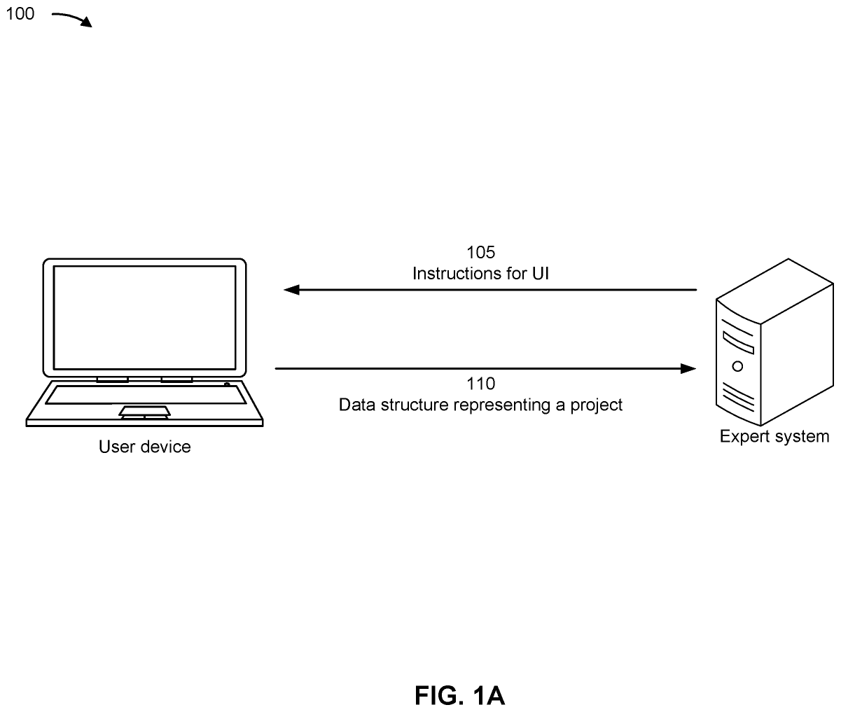

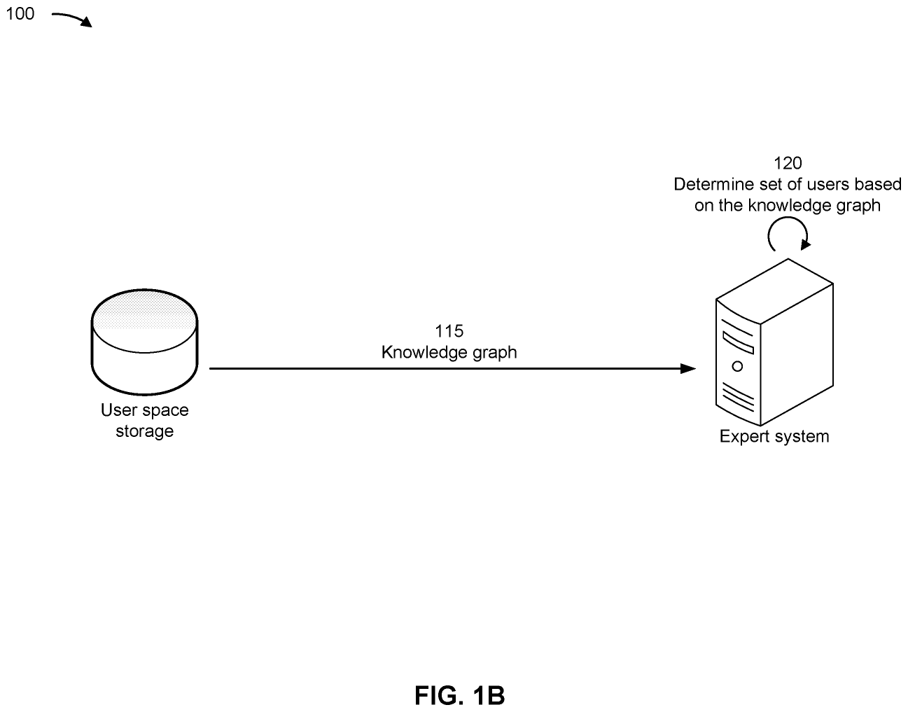

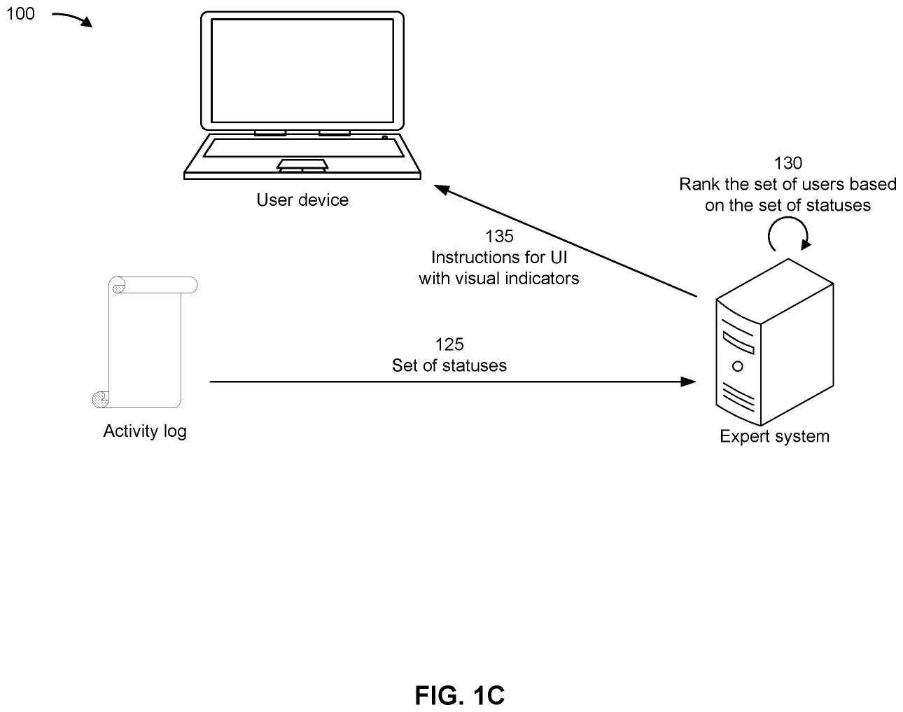

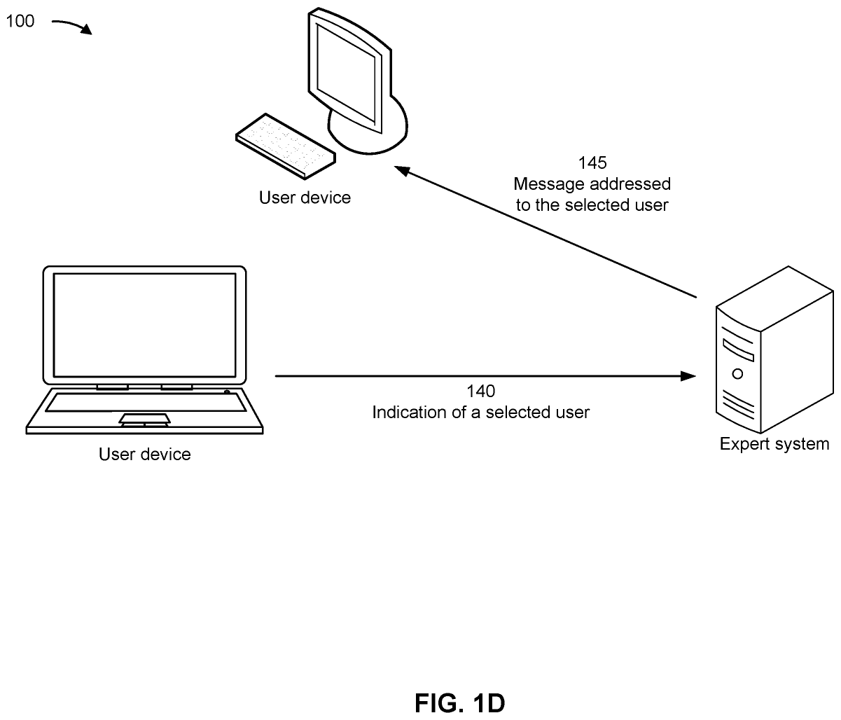

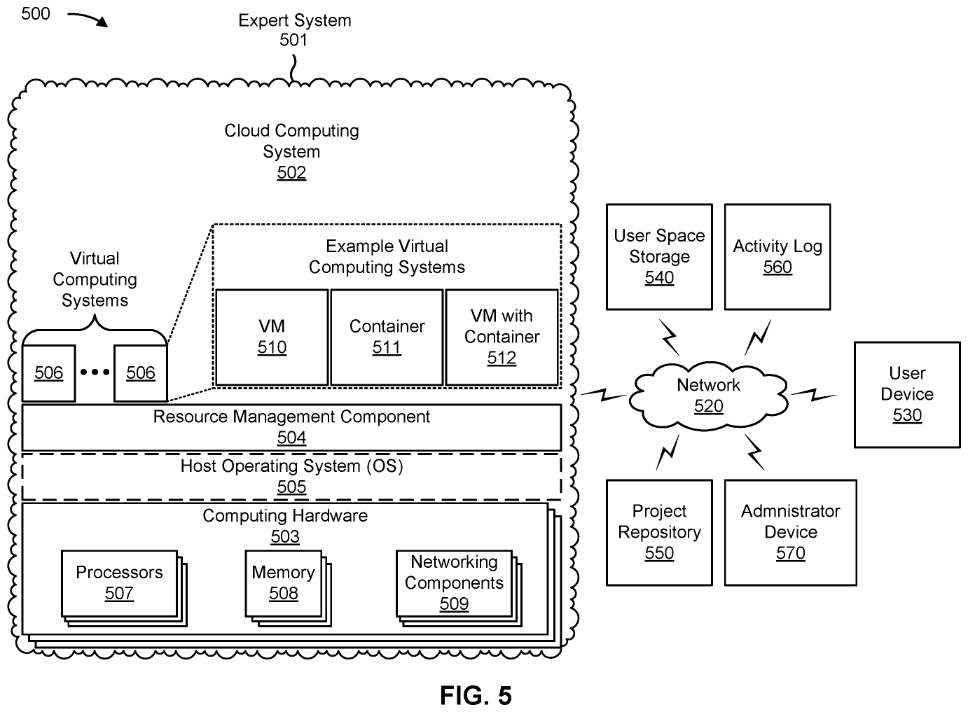

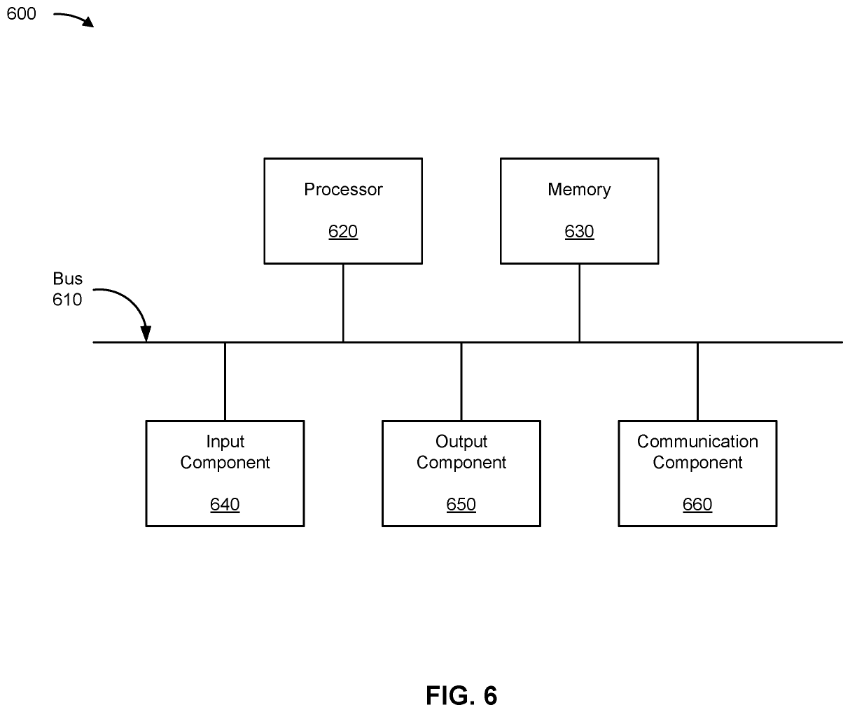

FIGS. 1A-1D are diagrams of an example 100 associated with applying graph representations of user spaces to a new project. As shown in FIGS. 1A-1D, example 100 includes user devices, an expert system, a user space storage, and an activity log. These devices are described in more detail in connection with FIGS. 5 and 6.

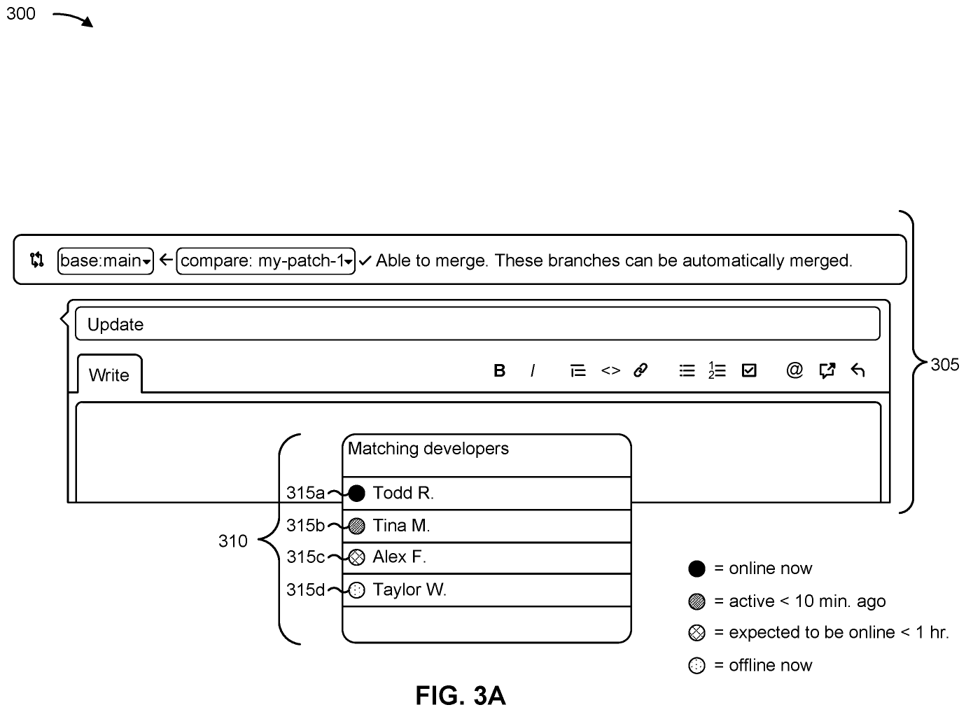

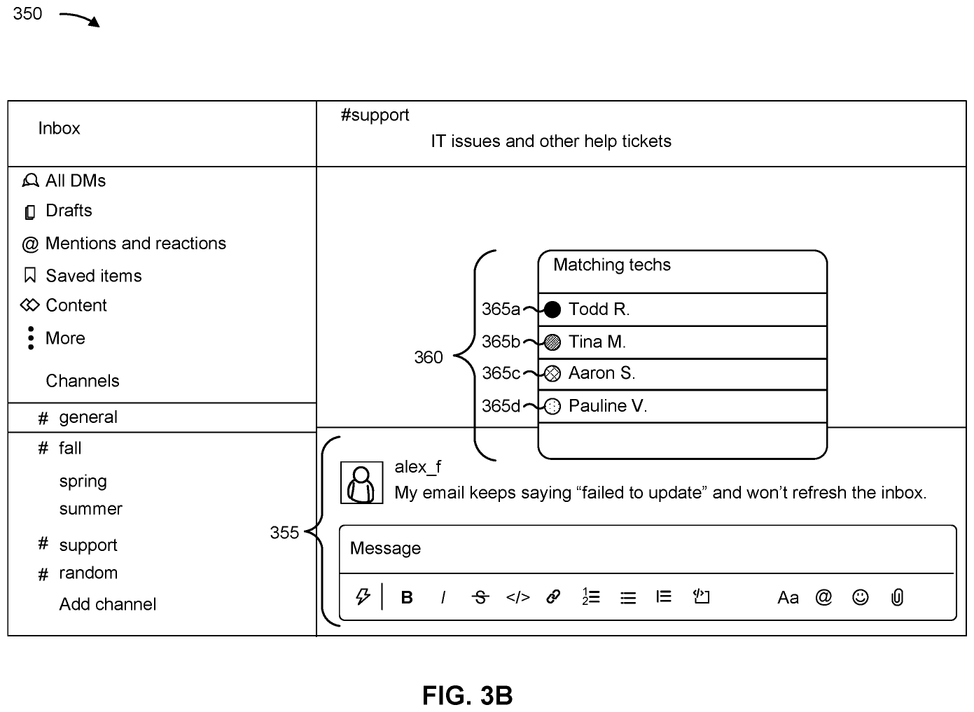

As shown in FIG. 1A and by reference number 105, the expert system may transmit, and a user device (e.g., associated with a person submitting a project) may receive, instructions for a user interface (UI) including input elements (e.g., one or more input elements). The UI may be as described in FIG. 3A or in FIG. 3B. The input elements may include a text box, a drop-down menu, a set of radio buttons, or a checkbox, among other examples. The input elements may be associated with fields in a data structure associated with the project. For example, each input element may map to a field in the data structure on a one-to-one basis or may map to a plurality of fields on a one-to-many basis.

In some implementations, the user device may transmit, and the expert device may receive, a request for the UI (e.g., in response to input that triggers the user device to transmit the request). For example, a web browser executed by the user device may transmit a hypertext transfer protocol (HTTP) request and/or may perform a call to an application programming interface (API) function associated with the expert device. Therefore, the expert device may transmit the instructions in response to the request.

As shown by reference number 110, the user device may transmit, and the expert system may receive, a data structure representing the project. The project may be associated with a technical request (that is, associated with a problem to be solved for a piece of hardware and/or a piece of software). For example, the project may include an IT ticket, a feature suggestion, or a code pull request, among other examples. A “technical request” may also be referred to as a “technical inquiry.” The data structure may include a table, a graph, or another type of relational data structure indicating fields associated with the project and including values for the fields.

Although the example 100 is shown with the data structure being transmitted using the input elements of the UI, other examples may include the user device transmitting the data structure without showing the UI. For example, the user device may upload a file (or another type of data package across a set of packets) that encodes the data structure. The user device may transmit the data structure periodically (e.g., according to a schedule) or based on input triggering transmission of the data structure (e.g., using a put command).

As shown in FIG. 1B and by reference number 115, the user space storage may transmit, and the expert system may receive, a knowledge graph. The user space storage may be local to the expert system (e.g., included in a memory controlled by the expert system), and thus the expert system may retrieve the knowledge graph locally. Alternatively, the user space storage may be at least partially external (e.g., logically, physically, and/or virtually) from the expert system, and thus the expert system may transmit a request (e.g., an HTTP request, an API call, or another type of message over a network), to the user space storage, for the knowledge graph. Accordingly, the user space storage may transmit, and the expert system may receive, a response including the knowledge graph.

The knowledge graph may include a graph representation of a user space. The user space may comprise a mathematical representation of subject matter experts (SMEs) (referred to herein as “users” because the SMEs use the expert system to receive assignments). The SMEs may be represented along a plurality of dimensions. For example, one or more dimensions may be associated with keywords extracted from data structures associated with previous projects completed by the SMEs. Additionally, or alternatively, one or more dimensions may be associated with tags for certifications, self-reported skills, and/or peer-report skills, among other examples. Additionally, or alternatively, one or more dimensions may be associated with published papers authored by the SMEs, filenames of files created or modified by the SMEs, and/or features in production associated with the SMEs, among other examples. Additionally, or alternatively, one or more dimensions may be associated with reviews of previous projects completed by the SMEs (e.g., numerical scores of quality and/or keywords extracted from text-based reviews, among other examples). Therefore, expertises of the SMEs may be spatially represented between nodes in the graph representation, where each node represents one of the SMEs.

In some implementations, the expert system may generate the graph representation of the user space. For example, the expert system may vectorize a plurality of data structures, associated with completed projects, associated with the SMEs. In some implementations, the plurality of data structures may encode reviews associated with the completed projects (e.g., from customers and/or bosses), and the expert system may vectorize the reviews (e.g., directly using numerical scores in the reviews and/or extracting keywords from text of the reviews, among other examples). Additionally, or alternatively, as described above, the expert system may vectorize certifications, self-reported skills, peer-report skills, published papers, filenames of files, and/or features in production associated with the SMEs. Accordingly, the expert system may store the graph representation in the user space storage for re-use in a future assignment of a new project. As described above, the user space storage may be local to the expert system (e.g., included in a memory controlled by the expert system), and thus the expert system may store the graph representation locally. Alternatively, the user space storage may be at least partially external (e.g., logically, physically, and/or virtually) from the expert system, and thus the expert system may transmit a request (e.g., an HTTP request, an API call, or another type of message over a network), to the user space storage, that includes the graph representation to store. In some implementations, the user space storage may transmit, and the expert system may receive, a confirmation that the graph representation was stored.

As shown by reference number 120, the expert system may determine a set of users for the project based on the knowledge graph. In some implementations, the expert system may extract keywords (e.g., one or more keywords) from the data structure and/or properties (e.g., one or more properties) from the data structure. Therefore, the expert system may apply the keywords and the properties to the graph representation of the user space in order to determine the set of users from the SMEs represented in the user space. The expert system may determine the keywords by extracting words, included in a narrative in the data structure, that are included on a list of keywords. Additionally, or alternatively, the expert system may determine the keywords as nouns and/or verbs associated with a frequency that satisfies a frequency threshold. The frequency may be global, such that the frequency threshold may be small (e.g., such that more technical and more specialized words are extracted). Additionally, or alternatively, the frequency may be relative to a piece of technology associated with the project, such that the frequency threshold may be large (e.g., words more commonly used in connection with the piece of technology are extracted). The properties may include a subject matter associated with the project (e.g., a field in the data structure including a tag associated with a category of the subject matter), a filename associated with the project (e.g., a filename in a code repository), and/or a deadline associated with the project (e.g., a datetime included in a field of the data structure).

More broadly, the expert system may map the data structure to the graph representation. For example, the set of users may be represented as nodes within the graph representation and selected based on distances between the nodes and a vectorized representation of the data structure. The set of users may be selected based on the distances satisfying a distance threshold and/or based on selecting a top quantity of users that are closest to the vectorized representation of the data structure regardless of absolute values of distances (e.g., selecting the top five users that are closest).

As shown in FIG. 1C and by reference number 125, the activity log may transmit, and the expert system may receive, an indication of a set of statuses, corresponding to the set of users, associated with availability of the set of users. The activity log may be local to the expert system (e.g., included in a memory controlled by the expert system), and thus the expert system may retrieve the indication locally. Alternatively, the activity log may be at least partially external (e.g., logically, physically, and/or virtually) from the expert system, and thus the expert system may transmit a request (e.g., an HTTP request, an API call, or another type of message over a network), to the activity log, for the set of statuses. Accordingly, the activity log may transmit, and the expert system may receive, a response including the indication.

As shown by reference number 130, the expert system may rank each user, in the set of users, according to the corresponding set of statuses. In some implementations, the expert system may determine the set of statuses by determining which users, in the set of users, are currently online. Accordingly, the expert system may prioritize users that are currently online over users that are currently offline.

Additionally, or alternatively, the expert system may determine the set of statuses by determining a most recent active time for at least one user in the set. Accordingly, the expert system may prioritize users that were more recently active over users that were active further in the past. Additionally, or alternatively, based on historical activity from the set of users (e.g., provided by the activity log), the expert system may predict a break for the at least one user (e.g., based on break lengths that occurred around a same time as the current time in the historical activity or an average or median break length in the historical activity, among other examples). Accordingly, the expert system may prioritize users for whom predicted breaks end closer to the current time over users for whom predicted breaks end further in the future.

Additionally, or alternatively, the expert system may determine the set of statuses by determining an expected schedule for each user in the set of users. For example, based on historical activity from the set of users (e.g., provided by the activity log), the expert system may predict working hours for each user. Additionally, or alternatively, the expert system may receive (e.g., from a scheduling system, an email server, or time tracking software, among other examples) an indication of scheduled events for each user. For example, based on event invites associated with the set of users, the expert system may predict working hours for each user (e.g., when the user is scheduled to work and/or not scheduled for a meeting). The expert system may therefore prioritize users whose working hours overlap with the current time over users whose working hours are non-overlapping. Additionally, or alternatively, the expert system may prioritize users whose working hours begin closer to the current time over users whose working hours begin further in the future.

Additionally, or alternatively, the expert system may determine the set of statuses by determining a current workload for each user in the set of users. For example, the expert system may receive (e.g., from a ticket system, such as a project repository described herein, among other examples) an indication of existing projects currently assigned to each user. Accordingly, the expert system may prioritize users with fewer existing projects over users with more existing projects. Additionally, or alternatively, the expert system may sum, for each user, an expected time to completion associated with each existing project currently assigned to the user. Accordingly, the expert system may prioritize users with a smaller total expected time to completion over users with a larger total expected time to completion.

The expert system may combine the ranking criteria, as described above, sequentially. For example, the expert system may prioritize users that are currently online followed by users that were more recently active. In another example, the expert system may prioritize users that were more recently active followed by users whose predicted schedules overlap with the current time. Alternatively, the expert system may combine the ranking criteria, as described above, holistically. For example, the expert system may score users based on current statuses, most recent active times, predicted schedules, and/or workloads and rank the set of users based on score.

Although the example 100 is described in connection with a sequential selection of users from the knowledge graph and ranking of users based on status, other examples may include a sequential selection of users based on status and ranking of users based on the knowledge graph. For example, the expert system may identify the set of users based on which users are currently active and/or expected to be active within a time window (e.g., as described above) and may rank the set of users based on distances between nodes representing the set of users and the vectorized representation of the data structure in the knowledge graph. Alternatively, other examples may consider statuses and the knowledge graph holistically. For example, the expert system may score potential users based on a combination of availability and the knowledge graph. Accordingly, the set of users may be selected based on holistic scoring rather than sequential consideration of availability and the knowledge graph.

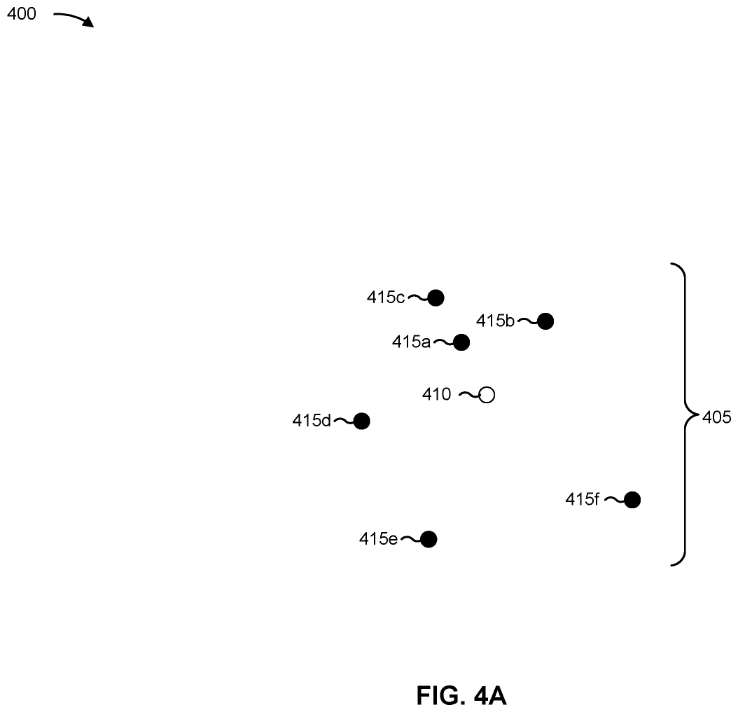

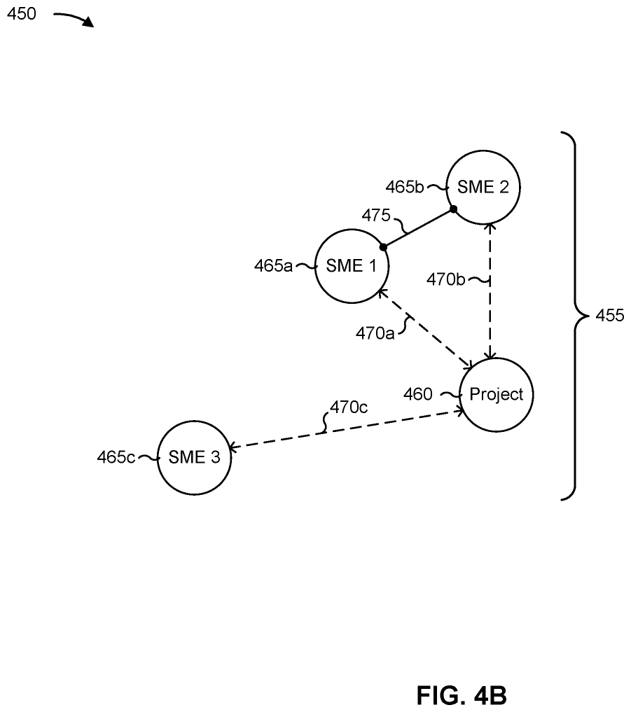

As shown by reference number 135, the expert system may transmit, and the user device may receive, instructions for a UI including visual indicators for the set of users and the set of statuses. As described in connection with FIGS. 3 and 4, the instructions for the UI may include instructions for a pop-up window. Additionally, or alternatively, the visual indicators may include colored elements corresponding to different availabilities. In FIGS. 3 and 4, different patterns are associated with active, recently active, expected to be active, and offline. Therefore, the set of users are selected and displayed based on both availability and expertise. As a result, memory overhead is reduced because the project will be completed faster, and thus the data structure associated with the project may be archived faster. Additionally, network overhead may be reduced because the project will be completed faster, and thus the user device will perform fewer status checks on the project with the expert system.

As shown in FIG. 1D and by reference number 140, the user device may transmit, and the expert system may receive, an indication of a selected user from the set of users. For example, an input component of the user device may receive a click, a tap, or a press of an “Enter” key, among other examples, associated with one of the visual indicators, associated with the selected user, as output in the UI. Accordingly, the user device may transmit the indication in response to an interaction with one of the visual indicators associated with the selected user.

Although the example 100 is described in connection with the user device assigning the project to the selected user out of the set of users, other examples may include the expert system automatically assigning the project to a highest-ranked user (or at least to a top-ranked user as defined by a rank order associated with the selected user satisfying a ranking threshold).

As shown by reference number 145, the expert system may transmit, and a user device (e.g., associated with the selected user) may receive, a message addressed to the selected user. In some implementations, the expert system may transmit an email message (e.g., via an email server) and/or a text message (e.g., via a cellular network) addressed to the selected user. For example, the expert system may map an identifier associated with the selected user (e.g., a name or a username, among other examples) to an email address and/or a phone number associated with the selected user and may use the email address to send the email message and/or use the phone number to send the text message. Additionally, or alternatively, the expert system may transmit instructions to modify a dashboard, associated with the selected user, to indicate the project. For example, the dashboard may include a table or another type of list that shows assigned projects for the selected user. Accordingly, the expert system may transmit instructions to add the project to the list for the selected user.

By using techniques as described in connection with FIGS. 1A-1D, the expert system assigns the project to the selected user based on a combination of the user space and the set of statuses. As a result, memory overhead is reduced because the project will be completed faster, and thus the data structure associated with the project may be archived faster. Additionally, network overhead may be reduced because the project will be completed faster, and thus the user device is less likely to perform repeated status checks on the project with the expert system.

As indicated above, FIGS. 1A-1D are provided as an example. Other examples may differ from what is described with regard to FIGS. 1A-1D.

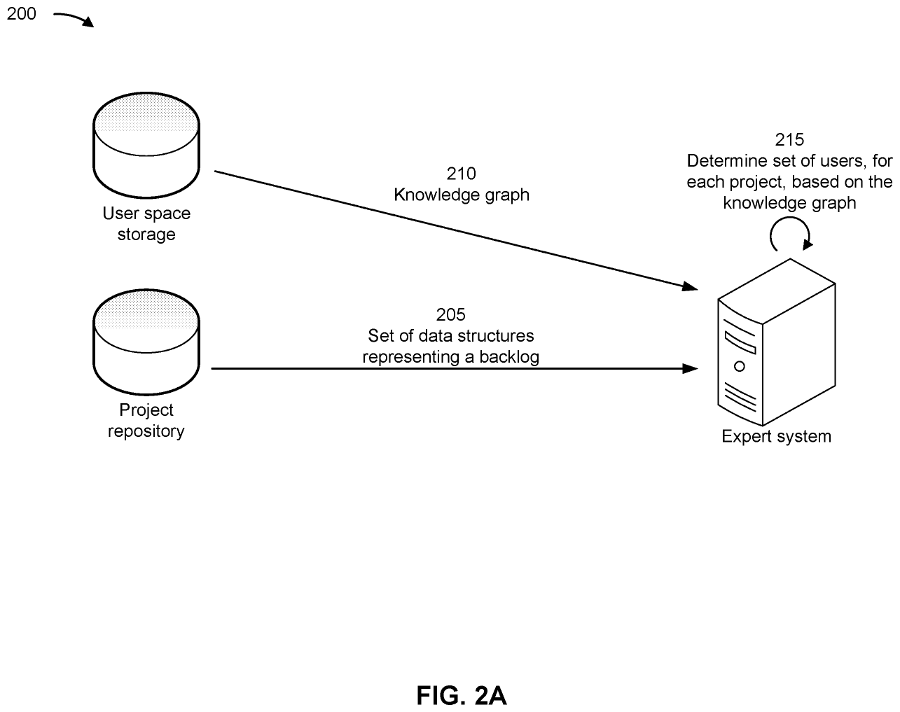

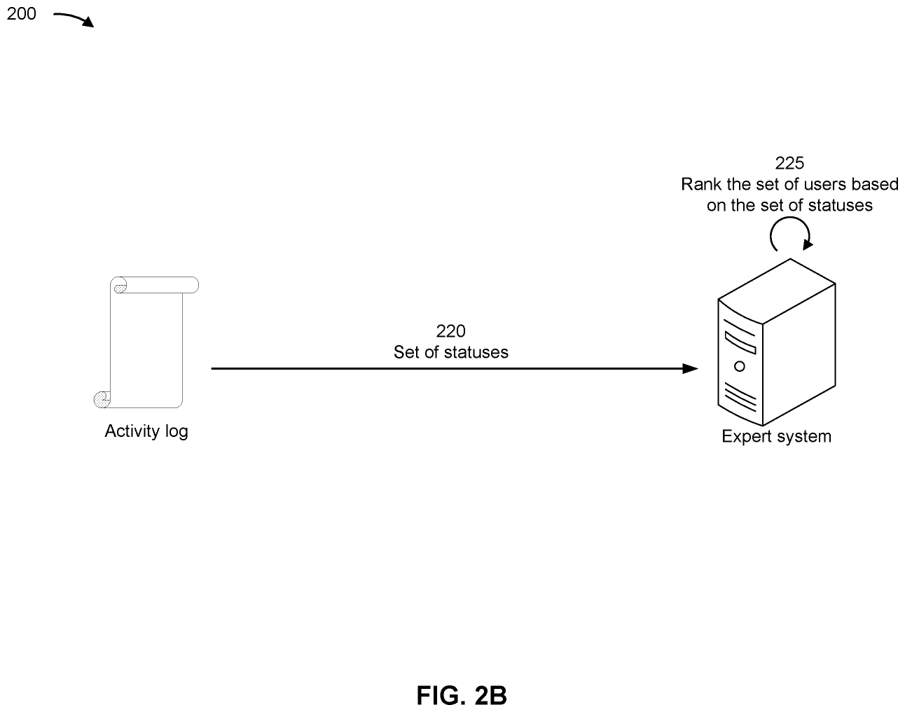

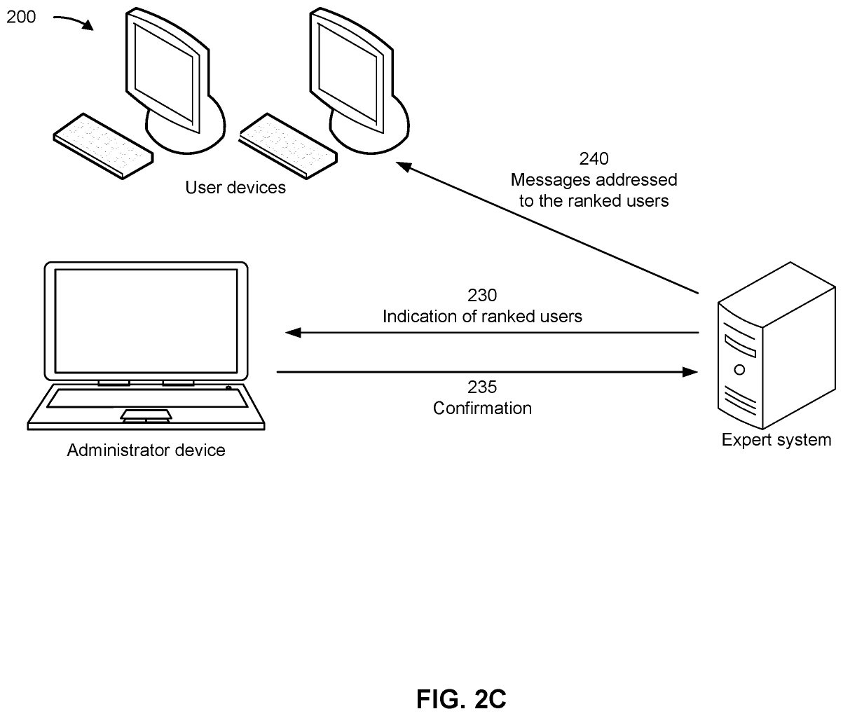

FIGS. 2A-2C are diagrams of an example 200 associated with applying graph representations of user spaces to a backlog. As shown in FIGS. 2A-2C, example 200 includes a project repository, an expert system, a user space storage, an activity log, an administrator device, and user devices. These devices are described in more detail in connection with FIGS. 5 and 6.

As shown in FIG. 2A and by reference number 205, the project repository may transmit, and the expert system may receive, a plurality of data structures representing a backlog. The backlog may include a plurality of projects, and the plurality of projects may be associated with technology. For example, the plurality of projects may include IT tickets, feature suggestions, and/or code pull requests, among other examples. The plurality of data structures may include tables, graphs, and/or other types of relational data structures indicating fields associated with the projects and including values for the fields. The expert system may transmit a request and receive the plurality of data structures in response to the request. The request may be transmitted periodically (e.g., according to a schedule) or in response to input that triggers transmission of the request. Additionally, or alternatively, the project repository may push the plurality of data structures to the expert system. The plurality of data structures may be transmitted periodically (e.g., according to a schedule) or in response to input that triggers transmission of the plurality of data structures.

In some implementations, the project repository may include a ticket system, and the project repository may transmit a request for tickets that are incomplete to the ticket system. Accordingly, the expert system may receive (at least a portion of) the plurality of data structures from the ticket system in response to the request. Additionally, or alternatively, the expert system may receive (at least a portion of) the plurality of data structures from the administrator device. For example, an administrator may provide input (e.g., via an input component) that triggers the administrator device to transmit the plurality of data structures.

As shown by reference number 210, the user space storage may transmit, and the expert system may receive, a knowledge graph. The expert system may receive the knowledge graph as described in connection with reference number 115 of FIG. 1B. As described in connection with FIG. 1B, the knowledge graph may include a graph representation of a user space.

As shown by reference number 215, the expert system may determine, for each data structure in the plurality of data structures, a corresponding set of users based on a graph representation of a user space. For example, the expert system may determine each corresponding set of users as described in connection with reference number 120 of FIG. 1B.

As shown in FIG. 2B and by reference number 220, the activity log may transmit, and the expert system may receive, for each corresponding set of users, an indication of a set of statuses indicating availability of the corresponding set of users. The expert system may therefore determine, for each corresponding set of users, the associated set of statuses as described in connection with reference number 125 of FIG. 1C.

As shown by reference number 225, the expert system may rank each corresponding set of users according to the associated set of statuses. For example, the expert system may rank each corresponding set of users as described in connection with reference number 130 of FIG. 1C. Although the example 100 is described in connection with a sequential selection of users from the knowledge graph and ranking of users based on status, other examples may include a sequential selection of users based on status and ranking of users based on the knowledge graph. For example, the expert system may identify each corresponding set of users based on which users are currently active and/or expected to be active within a time window and may rank the corresponding set of users based on distances between nodes representing the corresponding set of users and a vectorized representation of one of the plurality of data structures in the knowledge graph. Alternatively, other examples may consider statuses and the knowledge graph holistically. For example, the expert system may score potential users based on a combination of availability and the knowledge graph. Accordingly, the corresponding set of users may be selected based on holistic scoring rather than sequential consideration of availability and the knowledge graph.

Therefore, each corresponding set of users is selected based on both availability and expertise. As a result, memory overhead is reduced because the backlog will be completed faster, and thus the plurality of data structures may be archived faster. As shown in FIG. 2C by reference number 230, the expert system may transmit, and the administrator device may receive, an indication of ranked users for each data structure. In some implementations, the indication may include a UI, similar to the UIs described in connection with FIGS. 3 and 4, that shows the ranked users for each data structure along with corresponding visual indicators.

As shown by reference number 235, the administrator device may transmit, and the expert system may receive, a confirmation. For example, an input component of the administrator device may receive a click, a tap, or a press of an “Enter” key, among other examples, associated with each corresponding set of users as output in the UI. Accordingly, the administrator device may transmit the confirmation in response to an interaction with the indication of ranked users. Alternatively, the administrator device may select a lower-ranked user, out of the corresponding set of users, for at least one of the data structures. Accordingly, the administrator device may override a proposed allocation of the backlog by the expert system. Although the example 200 is described in connection with the administrator device confirming assignments of the backlog, other examples may include the expert system automatically assigning the backlog to top-ranked users.

As shown by reference number 240, the expert system may transmit, and a user device (e.g., associated with a top-ranked user in a corresponding set of users) may receive, a message addressed to the top-ranked user. In some implementations, the expert system may transmit an email message (e.g., via an email server) and/or a text message (e.g., via a cellular network) addressed to the top-ranked user. For example, the expert system may map an identifier associated with the top-ranked user (e.g., a name or a username, among other examples) to an email address and/or a phone number associated with the top-ranked user and may use the email address to send the email message and/or use the phone number to send the text message. Additionally, or alternatively, the expert system may transmit instructions to modify a dashboard, associated with the top-ranked user, to indicate an assigned data structure (or data structures) from the backlog. For example, the dashboard may include a table or another type of list that shows assigned projects for the top-ranked user. Accordingly, the expert system may transmit instructions to add to the list, from the backlog, for the top-ranked user.

By using techniques as described in connection with FIGS. 2A-2C, the expert system allocates the backlog to top-ranked users based on a combination of the user space and the associated sets of statuses. As a result, memory overhead is reduced because the backlog will be completed faster, and thus the plurality of data structures associated with the backlog may be archived faster.

As indicated above, FIGS. 2A-2C are provided as an example. Other examples may differ from what is described with regard to FIGS. 2A-2C.

FIG. 3A is a diagram of an example UI 300 associated with user statuses described herein. The example UI 300 shown in FIG. 3A may be output by a user device based on instructions from an expert system. These devices are described in more detail in connection with FIGS. 5 and 6.

As shown in FIG. 3A, the example UI 300 may include a set 305 of input elements associated with a code pull request. As further shown in FIG. 3A, the example UI 300 may include a pop-up window 310. The pop-up window 310 includes a plurality of visual indicators (e.g., indicator 315a, indicator 315b, indicator 315c, and indicator 315d in FIG. 3A). Each visual indicator may include a colored, shaded, or (as shown in FIG. 3A) patterned element that corresponds to a status. In FIG. 3A, the different patterns correspond to a status of “online now,” “active less than 10 minutes ago” (other examples may use a different threshold), “expected to be online within 1 hour” (other examples may use a different threshold), and “offline now.” Other examples may include fewer statuses or additional statuses (e.g., “expected to be off break soon,” “expected to be out of a meeting soon,” “expected to take a break soon,” “expected to leave work soon,” or “expected to join a meeting soon,” among other examples).

FIG. 3B is a diagram of an example UI 350 associated with user statuses described herein. The example UI 350 shown in FIG. 3B may be output by a user device based on instructions from an expert system. These devices are described in more detail in connection with FIGS. 5 and 6.

As shown in FIG. 3B, the example UI 350 may include a set 355 of input elements associated with an IT request. As further shown in FIG. 3B, the example UI 350 may include a pop-up window 360. The pop-up window 360 includes a plurality of visual indicators (e.g., indicator 365a, indicator 365b, indicator 365c, and indicator 365d in FIG. 3B). Each visual indicator may include a colored, shaded, or (as shown in FIG. 3B) patterned element that corresponds to a status. In FIG. 3B, the different patterns correspond to a status of “online now,” “active less than 10 minutes ago” (other examples may use a different threshold), “expected to be online within 1 hour” (other examples may use a different threshold), and “offline now.” Other examples may include fewer statuses or additional statuses (e.g., “expected to be off break soon,” “expected to be out of a meeting soon,” “expected to take a break soon,” “expected to leave work soon,” or “expected to join a meeting soon,” among other examples).

As indicated above, FIGS. 3A-3B are provided as examples. Other examples may differ from what is described with regard to FIGS. 3A-3B.

FIG. 4A is a diagram of an example UI 400 associated with a knowledge graph described herein. The example UI 400 shown in FIG. 4A may be output by a user device based on instructions from an expert system. These devices are described in more detail in connection with FIGS. 5 and 6.

As shown in FIG. 4A, the example UI 400 may include a graph 405. The graph 405 may include a node 410 representing an SME. Additionally, the graph 405 may include nodes 415 associated with previous projects assigned to the SME. For example, nodes 415a, 415b, and 415c are represented with a shorter distance to the node 410 because the previous projects are completed and/or are associated with more positive reviews. On the other hand, nodes 415d, 415e, and 415f are represented with a longer distance to the node 410 because the previous projects are incomplete and/or are associated with less positive reviews. The nodes 415 may represent all previous projects assigned to the SME or only a set of previous projects that are related to a current project (e.g., based on keyword mapping, as described in connection with FIG. 1B).

FIG. 4B is a diagram of an example UI 450 associated with a knowledge graph described herein. The example UI 450 shown in FIG. 4B may be output by a user device based on instructions from an expert system. These devices are described in more detail in connection with FIGS. 5 and 6.

As shown in FIG. 4B, the example UI 450 may include a graph 455. The graph 455 may include a node 460 representing a project (e.g., associated with a technical request, as described in connection with FIG. 1A). Additionally, the graph 455 may include nodes 465 associated with SMEs. For example, node 465a represents an SME and has a shortest distance 470a to the node 460. The shortest distance 470a visually depicts that the SME represented by the node 465a is a best match for the project (e.g., based on expertise and/or availability, as described in connection with FIGS. 1B-1C). On the other hand, node 465b is a longer distance 470b to the node 460, and node 465c is the longest distance 470c to the node 460. Therefore, the graph 455 may visually depict the ranking described in connection with FIG. 1C.

As further shown in FIG. 4B, the node 465a is depicted as having a connection 475 to the node 465b. Accordingly, the connection 475 represents that the SME represented by the node 465a works with the SME represented by the node 465b (e.g., on a same team and/or based on previous projects completed by the SMEs). A length of the connection 475 may be based on a degree of connectedness between the SMEs (e.g., a distance on an organization charge between the SMEs and/or a quantity of previous projects completed by the SMEs together, among other examples). A lack of connection between the node 465c and the nodes 465a and 465b shows that the SME represented by the node 465c is on a different team (or otherwise does not work with) the SMEs represented by the nodes 465a and 465b.

As indicated above, FIGS. 4A-4B are provided as examples. Other examples may differ from what is described with regard to FIGS. 4A-4B.

FIG. 5 is a diagram of an example environment 500 in which systems and/or methods described herein may be implemented. As shown in FIG. 5, environment 500 may include an expert system 501, which may include one or more elements of and/or may execute within a cloud computing system 502. The cloud computing system 502 may include one or more elements 503-512, as described in more detail below. As further shown in FIG. 5, environment 500 may include a network 520, a user device 530, a user space storage 540, a project repository 550, an activity log 560, and/or an administrator device 570. Devices and/or elements of environment 500 may interconnect via wired connections and/or wireless connections.

The cloud computing system 502 may include computing hardware 503, a resource management component 504, a host operating system (OS) 505, and/or one or more virtual computing systems 506. The cloud computing system 502 may execute on, for example, an Amazon Web Services platform, a Microsoft Azure platform, or a Snowflake platform. The resource management component 504 may perform virtualization (e.g., abstraction) of computing hardware 503 to create the one or more virtual computing systems 506. Using virtualization, the resource management component 504 enables a single computing device (e.g., a computer or a server) to operate like multiple computing devices, such as by creating multiple isolated virtual computing systems 506 from computing hardware 503 of the single computing device. In this way, computing hardware 503 can operate more efficiently, with lower power consumption, higher reliability, higher availability, higher utilization, greater flexibility, and lower cost than using separate computing devices.

The computing hardware 503 may include hardware and corresponding resources from one or more computing devices. For example, computing hardware 503 may include hardware from a single computing device (e.g., a single server) or from multiple computing devices (e.g., multiple servers), such as multiple computing devices in one or more data centers. As shown, computing hardware 503 may include one or more processors 507, one or more memories 508, and/or one or more networking components 509. Examples of a processor, a memory, and a networking component (e.g., a communication component) are described elsewhere herein.

The resource management component 504 may include a virtualization application (e.g., executing on hardware, such as computing hardware 503) capable of virtualizing computing hardware 503 to start, stop, and/or manage one or more virtual computing systems 506. For example, the resource management component 504 may include a hypervisor (e.g., a bare-metal or Type 1 hypervisor, a hosted or Type 2 hypervisor, or another type of hypervisor) or a virtual machine monitor, such as when the virtual computing systems 506 are virtual machines 510. Additionally, or alternatively, the resource management component 504 may include a container manager, such as when the virtual computing systems 506 are containers 511. In some implementations, the resource management component 504 executes within and/or in coordination with a host operating system 505.

A virtual computing system 506 may include a virtual environment that enables cloud-based execution of operations and/or processes described herein using computing hardware 503. As shown, a virtual computing system 506 may include a virtual machine 510, a container 511, or a hybrid environment 512 that includes a virtual machine and a container, among other examples. A virtual computing system 506 may execute one or more applications using a file system that includes binary files, software libraries, and/or other resources required to execute applications on a guest operating system (e.g., within the virtual computing system 506) or the host operating system 505.

Although the expert system 501 may include one or more elements 503-512 of the cloud computing system 502, may execute within the cloud computing system 502, and/or may be hosted within the cloud computing system 502, in some implementations, the expert system 501 may not be cloud-based (e.g., may be implemented outside of a cloud computing system) or may be partially cloud-based. For example, the expert system 501 may include one or more devices that are not part of the cloud computing system 502, such as device 600 of FIG. 6, which may include a standalone server or another type of computing device. The expert system 501 may perform one or more operations and/or processes described in more detail elsewhere herein.

The network 520 may include one or more wired and/or wireless networks. For example, the network 520 may include a cellular network, a public land mobile network (PLMN), a local area network (LAN), a wide area network (WAN), a private network, the Internet, and/or a combination of these or other types of networks. The network 520 enables communication among the devices of the environment 500.

The user device 530 may include one or more devices capable of receiving, generating, storing, processing, and/or providing information associated with technology projects, as described elsewhere herein. The user device 530 may include a communication device and/or a computing device. For example, the user device 530 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 530 may communicate with one or more other devices of environment 500, as described elsewhere herein.

The user space storage 540 may include one or more devices capable of receiving, generating, storing, processing, and/or providing information associated with user spaces, as described elsewhere herein. The user space storage 540 may include a communication device and/or a computing device. For example, the user space storage 540 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The user space storage 540 may communicate with one or more other devices of environment 500, as described elsewhere herein.

The project repository 550 may include one or more devices capable of receiving, generating, storing, processing, and/or providing information associated with technology projects, as described elsewhere herein. The project repository 550 may include a communication device and/or a computing device. For example, the project repository 550 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the project repository 550 may include issue tracking software and/or project management software, such as Jira® or Bugzilla®, among other examples. The project repository 550 may communicate with one or more other devices of environment 500, as described elsewhere herein.

The activity log 560 may include one or more devices capable of receiving, generating, storing, processing, and/or providing information associated with user statuses, as described elsewhere herein. The activity log 560 may include a communication device and/or a computing device. For example, the activity log 560 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The activity log 560 may communicate with one or more other devices of environment 500, as described elsewhere herein.

The administrator device 570 may include one or more devices capable of receiving, generating, storing, processing, and/or providing information associated with technology projects, as described elsewhere herein. The administrator device 570 may include a user device 530 that is associated with higher-level access to (e.g., administrator privileges on) the expert system 501. For example, the administrator device 570 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 570 may communicate with one or more other devices of environment 500, as described elsewhere herein.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of the environment 500 may perform one or more functions described as being performed by another set of devices of the environment 500.

FIG. 6 is a diagram of example components of a device 600 associated with applying graph representations of user spaces. The device 600 may correspond to a user device 530, a user space storage 540, a project repository 550, an activity log 560, and/or an administrator device 570. In some implementations, the user device 530, the user space storage 540, the project repository 550, the activity log 560, and/or the administrator device 570 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

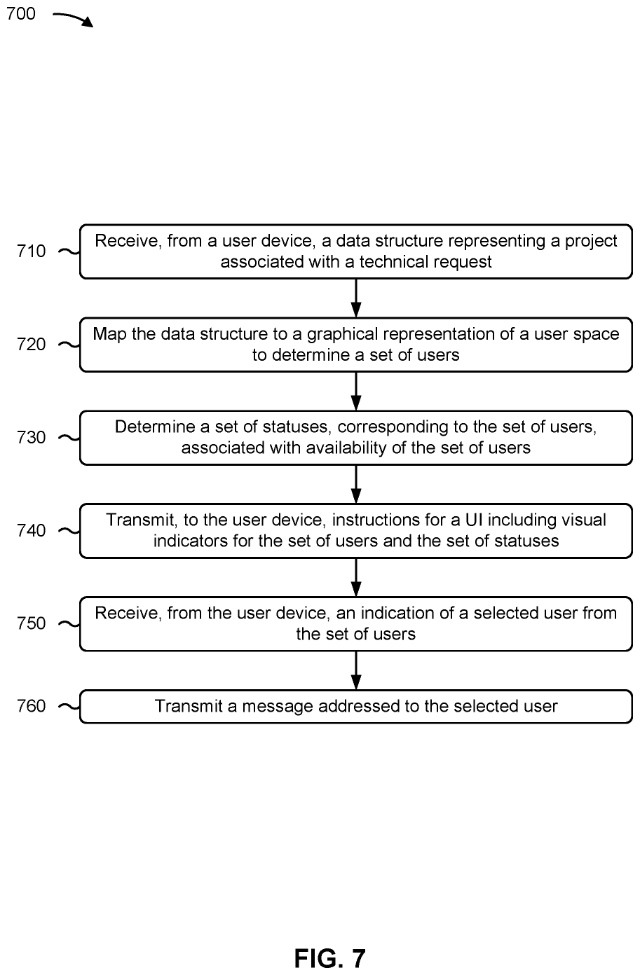

FIG. 7 is a flowchart of an example process 700 associated with applying graph representations of user spaces. In some implementations, one or more process blocks of FIG. 7 may be performed by the expert system 501. In some implementations, one or more process blocks of FIG. 7 may be performed by another device or a group of devices separate from or including the expert system 501, such as a user device 530, a user space storage 540, a project repository 550, an activity log 560, and/or an administrator device 570. Additionally, or alternatively, one or more process blocks of FIG. 7 may be performed by one or more components of the device 600, such as processor 620, memory 630, input component 640, output component 650, and/or communication component 660.

As shown in FIG. 7, process 700 may include receiving, from a user device, a data structure representing a project associated with a technical request (block 710). For example, the expert system 501 (e.g., using processor 620, memory 630, input component 640, and/or communication component 660) may receive, from a user device, a data structure representing a project associated with a technical request, as described above in connection with reference number 110 of FIG. 1A. As an example, the project may include an IT ticket, a feature suggestion, or a code pull request, among other examples, and the data structure may include a table, a graph, or another type of relational data structure indicating fields associated with the project and including values for the fields.

As further shown in FIG. 7, process 700 may include mapping the data structure to a graph representation of a user space to determine a set of users (block 720). For example, the expert system 501 (e.g., using processor 620 and/or memory 630) may map the data structure to a graph representation of a user space to determine a set of users, as described above in connection with reference number 120 of FIG. 1B. As an example, the set of users may be represented as nodes within the graph representation, and the expert system 501 may select the set of users based on distances between the nodes and a vectorized representation of the data structure. The expert system 501 may select the set of users based on the distances satisfying a distance threshold and/or based on selecting a top quantity of users that are closest to the vectorized representation of the data structure regardless of absolute value of distances (e.g., selecting the top five users that are closest).

As further shown in FIG. 7, process 700 may include determining a set of statuses, corresponding to the set of users, associated with availability of the set of users (block 730). For example, the expert system 501 (e.g., using processor 620 and/or memory 630) may determine a set of statuses, corresponding to the set of users, associated with availability of the set of users, as described above in connection with reference number 125 of FIG. 1C. As an example, an activity log may transmit, and the expert system 501 may receive, an indication of the set of statuses, corresponding to the set of users, associated with availability of the set of users.

As further shown in FIG. 7, process 700 may include transmitting, to the user device, instructions for a UI including visual indicators for the set of users and the set of statuses (block 740). For example, the expert system 501 (e.g., using processor 620, memory 630, and/or communication component 660) may transmit, to the user device, instructions for a UI including visual indicators for the set of users and the set of statuses, as described above in connection with reference number 135 of FIG. 1C. As an example, the instructions for the UI may include instructions for a pop-up window, as described in connection with FIGS. 3 and 4. The visual indicators may include elements corresponding to different availabilities such that the expert system 501 selects and outputs, for display, the set of users based on both availability and expertise.

As further shown in FIG. 7, process 700 may include receiving, from the user device, an indication of a selected user from the set of users (block 750). For example, the expert system 501 (e.g., using processor 620, memory 630, input component 640, and/or communication component 660) may receive, from the user device, an indication of a selected user from the set of users, as described above in connection with reference number 140 of FIG. 1D. As an example, an input component of the user device may receive a click, a tap, or a press of an “Enter” key, among other examples, associated with one of the visual indicators that is associated with the selected user. Accordingly, the user device may transmit, and the expert system 501 may receive, the indication of the selected user in response to an interaction with one of the visual indicators associated with the selected user.

As further shown in FIG. 7, process 700 may include transmitting a message addressed to the selected user (block 760). For example, the expert system 501 (e.g., using processor 620, memory 630, and/or communication component 660) may transmit a message addressed to the selected user, as described above in connection with reference number 145 of FIG. 1D. As an example, the expert system 501 may transmit an email message (e.g., via an email server) and/or a text message (e.g., via a cellular network) addressed to the selected user. Additionally, or alternatively, the expert system 501 may transmit instructions to modify a dashboard, associated with the selected user, to indicate the project.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1D, 2A-2C, 3, and/or 4. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for applying graph representations of user spaces, the system comprising:
one or more memories; and
one or more processors, communicatively coupled to the one or more memories, configured to:
transmit, to a user device, instructions for a user interface (UI) including one or more input elements;
receive, from the user device and based on the one or more input elements, a data structure representing a project associated with a technical request;
extract one or more keywords from the data structure;
extract one or more properties from the data structure;
determine a set of users for the project, based on applying the one or more keywords and the one or more properties to a graph representation of a user space;
determine a set of statuses, corresponding to the set of users, associated with availability of the set of users;
transmit, to the user device, instructions for a UI including visual indicators for the set of users and the set of statuses;
receive, from the user device, an indication of a selected user from the set of users; and
transmit a message addressed to the selected user.

2. The system of claim 1, wherein the instructions for the UI including the visual indicators comprises instructions for a pop-up window.

3. The system of claim 1, wherein the visual indicators comprise colored elements corresponding to different availabilities.

4. The system of claim 1, wherein the one or more properties include a subject matter associated with the project, a filename associated with the project, or a deadline associated with the project.

5. The system of claim 1, wherein the one or more processors, to determine the set of statuses, are configured to:
determine which users, in the set of users, are currently online; and
determine a most recent active time for at least one user in the set of users.

6. The system of claim 1, wherein the one or more processors, to determine the set of statuses, are configured to:
determine an expected schedule for each user in the set of users.

7. The system of claim 1, wherein the one or more processors, to determine the set of statuses, are configured to:
determine a current workload for each user in the set of users.

8. A method of applying graph representations of user spaces, comprising:
receiving, from a user device, a data structure representing a project associated with a technical request;
mapping the data structure to a graph representation of a user space to determine a set of users;
determining a set of statuses, corresponding to the set of users, associated with availability of the set of users;
transmitting, to the user device, instructions for a user interface (UI) including visual indicators for the set of users and the set of statuses;
receiving, from the user device, an indication of a selected user from the set of users; and
transmitting a message addressed to the selected user.

9. The method of claim 8, wherein the project comprises an information technology ticket, a feature suggestion, or a code pull request.

10. The method of claim 8, further comprising:
generating the graph representation of the user space based on a plurality of data structures, associated with complete projects, associated with the set of users.

11. The method of claim 8, wherein mapping the data structure to the graph representation comprises:
selecting the set of users, represented as nodes within the graph representation, that are closest to a vectorized representation of the data structure.

12. The method of claim 8, wherein transmitting the message comprises:
transmitting an email message or a text message addressed to the selected user.

13. The method of claim 8, wherein transmitting the message comprises:
transmitting instructions to modify a dashboard, associated with the selected user, to indicate the project.

14. A non-transitory computer-readable medium storing a set of instructions for applying graph representations of user spaces, the set of instructions comprising:
one or more instructions that, when executed by one or more processors of a device, cause the device to:
receive a plurality of data structures representing a plurality of projects associated with technology;
determine, for each data structure in the plurality of data structures, a corresponding set of users based on a graph representation of a user space;
determine, for each corresponding set of users, an associated set of statuses indicating availability of the set of users;
rank each corresponding set of users according to the associated set of statuses; and
transmit, for each data structure, a message addressed to a top-ranked user in the corresponding set of users.

15. The non-transitory computer-readable medium of claim 14, wherein the one or more instructions, when executed by the one or more processors, further cause the device to:
receive, from an administrator device, a confirmation,
wherein each message is transmitted in response to the confirmation.

16. The non-transitory computer-readable medium of claim 14, wherein the one or more instructions, that cause the device to receive the plurality of data structures, cause the device to:
transmit, to a ticket system, a request for tickets that are incomplete; and
receive the plurality of data structures from the ticket system in response to the request.

17. The non-transitory computer-readable medium of claim 14, wherein the one or more instructions, that cause the device to receive the plurality of data structures, cause the device to:
receive the plurality of data structures from an administrator device.

18. The non-transitory computer-readable medium of claim 14, wherein the one or more instructions, that cause the device to transmit the message, cause the device to:
transmit instructions to modify a dashboard associated with the top-ranked user.

19. The non-transitory computer-readable medium of claim 14, wherein the one or more instructions, that cause the device to transmit the message, cause the device to:
transmit an email message or a text message addressed to the top-ranked user.

20. The non-transitory computer-readable medium of claim 14, wherein the plurality of projects include an information technology ticket, a feature suggestion, or a code pull request.
